(19) United States
(12) Patent Application Publication
(10) Pub. No.: US 2011/0307291 A1
(43) Pub. Date: Dec. 15, 2011

(54) CREATING A CAPACITY PLANNING SCENARIO

(76) Inventors: Jerome Rolia, Kanata (CA); Shiva Prakash SM, Bangalore (IN); Mustazirul Islam, Rocklin, CA (US)

(21) Appl. No.: 12/815,207

(22) Filed: Jun. 14, 2010

(51) Int. Cl. G06Q 10/00

(52) U.S. Cl. 705/7.25; 705/7.12

(57) ABSTRACT

Systems and methods are described for creating a capacity planning scenario. In one example, a method includes maintaining a topology model of computing resources in a configuration management database. A workload model of workload constraints for workloads put on the computing resources is also maintained. The constraints include limits on at least one of how, when, and where the workload may be used with regards to the computing resources. A service model of business services for workloads put on the computing resources can also be maintained. The service model can include relationships between workloads and demand traces. Constraint tags can be assigned to computing resources within the topology model, workload model, and service model. The constraint tags can include information about topology relationships, workload constraints, and service model services. A capacity planning scenario can be generated for the business services, workloads, and resources based on the assigned constraint tags.

### BACKGROUND

Business services can be large applications, such as customer relationship management or electronic commerce applications, which can be used by enterprises. Such services can be important to the operation and success of the enterprises. Business services can be complex and have many application components, such as enterprise resource planning systems, databases, web application servers, and so forth. Business services are often deployed in data center facilities having dedicated physical servers and virtualized shared server pools.

Enterprises may sometimes use capacity modeling and planning to ensure appropriate system resources are available to handle the workloads of business services, to enable business capabilities, and to ensure target service levels are reached. Often enterprises may consider planning scenarios, such as: consolidating business services to shared resource pools (i.e., private clouds); re-allocating existing resources to better meet operational cost and performance goals; and evaluating the impact of outsourcing aspects of a service (e.g., to rely upon infrastructure-as-a-service or other services entirely).

Capacity planners for computing systems attempt to optimize business services on large and complex systems with a large number of server nodes which may be geographically dispersed. The workloads processed by the business services and the infrastructure in which business services are executed can change over time. Capacity planners can attempt to determine the impact of changes and what solutions to predicted performance issues will be most effective. Capacity planners often use models based on current system performance to predict how performance will change in response to anticipated or hypothetical changes to the workloads and infrastructure.

Current capacity planning strategies can involve a difficult and time-consuming process. A capacity planner may expend a great deal of time evaluating planning options and alternatives, only to subsequently discard those options or alternatives after discovering little or no advantage is gained by the options or alternatives. Capacity planners are also limited in the number of systems that can be planned for or the complexity of the systems due to the hands-on (e.g., manual) nature of current capacity planning strategies for creating and executing planning scenarios. Manual changes to capacity planning scenarios can also result in errors due to typological or logical mistakes by the capacity planner.

### BRIEF DESCRIPTION OF THE DRAWINGS

FIG. 1 is a block diagram of a system for capacity planning scenario creation in accordance with an example;

FIG. 2 is a flow diagram of capacity planning scenario creation in accordance with an example;

FIG. 3 is a flow diagram of a method for capacity planning scenario creation, including optimization, in accordance with an example; and

FIG. 4 is a block diagram of a system for capacity planning scenario creation in accordance with an example.

### DETAILED DESCRIPTION

Reference will now be made to the exemplary examples illustrated, and specific language will be used herein to describe the same. It will nevertheless be understood that no limitation of scope is thereby intended. Additional features and advantages will be apparent from the detailed description which follows, taken in conjunction with the accompanying drawings, which together illustrate, by way of example, features of capacity planning scenario creation.

Systems and methods are described for creating a capacity planning scenario. In one example, a method includes maintaining a topology model of information technology and its relationship to available computing resources in a configuration management database. A workload model of workload constraints for workloads put on the computing resources is also maintained. The workload constraints include limits on how, when, and/or where the workload may be used with regards to the computing resources. A service model of business services for workloads put on the computing resources can also be maintained. As a workload consumes computing resources, monitoring systems periodically measure its resource demands, including but not limited to CPU and memory usage, and store the measured demand values in a demand trace. The service model can include relationships between workloads and demand traces. Constraint tags can be assigned to computing resources within the topology model, workload model, and service model. The constraint tags can include information about topology relationships, workload constraints, and services. A capacity planning scenario can be generated for the available resources based on the assigned constraint tags.

Capacity planning scenarios as described herein can account for: a topology of business service application components and hardware infrastructure; constraints upon the services that may affect performance, reliability, and availability; service level requirements; constraints upon facilities such as power usage and space; software licensing; cost; and operational measures, such as resource usage and service levels.

Topology and constraint information can be captured in a Configuration Management Database (CMDB), while usage information can be captured in monitoring repositories. Manually collecting usage information, combining the usage information with topology and constraint information, and reflecting the usage information and/or the combination of usage information with the topology and constraint information in a planning scenario can be very time consuming and error prone according to prior systems and methods. Furthermore, information can change, increasing the difficulty in keeping planning models up-to-date in prior systems and methods. The creation of a planning scenario as described herein can involve automation of the creation, evaluation and execution of planning scenarios. Planning scenario creation, as described herein, can minimize the effort expended for optimizing business services while also maximizing business goals (user experience, SLAs). The planning scenario creation can minimize operational costs (power, space etc.) while also addressing constraints. Automation support for creating and evaluating planning scenarios can help enterprises better manage information technology (IT) environments.

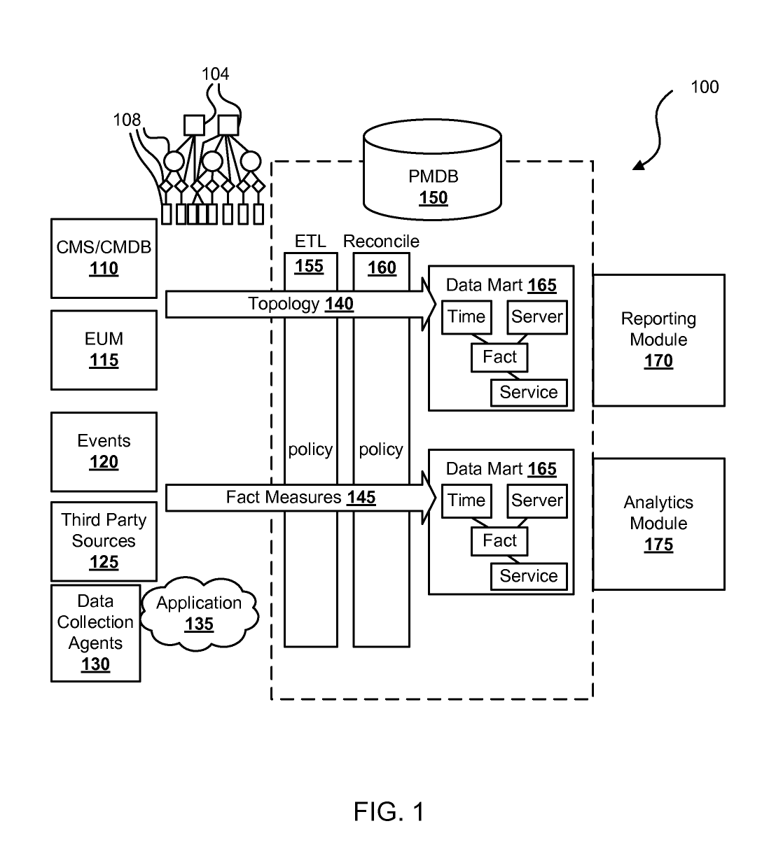

Referring to FIG. 1, a system 100 is shown for the creation of a capacity planning scenario. The capacity planning scenario can be created using a computing system and can be created for a computing environment. A business service 104 can have various sources of information that describe the configuration, behavior, and resource usage of the service. As shown in FIG. 1, some of these sources of information can include: a configuration management system (CMS) 110, a universal configuration management database (uCMDB) or CMDB 110, an end-user manager reporting system for user level metrics (EUM) 115, an events log 120, and third-party sources 125. The CMS and uCMDB can provide topology 140 and service level information. In one aspect, the CMDB can maintain a topology model of available computing resources. The topology model can include computing devices 108 within the system topology. In one aspect, the topology model can also include facilities in which the computing devices are used. The facilities information may comprise a facilities model within the topology model. The inclusion of facilities information with computing device topology information can allow for a capacity planner to not only plan according to projected system resource usage, or a projected number of users, but also according to how much space, power, etc. is available in a particular facility for upgrading to accommodate the projected system resource usage or projected number of users, for example.

As used herein, a “uCMDB” or “CMDB” is a repository that contains management information about business services. The information can be organized according to Business Service Models with elements named Configuration Items (CI). The CIs describe managed objects, their relationships, and constraints. A Topology Query Language (TQL) can provide an SQL-like language to interface with CMDB systems. CMDBs not only act as repositories for the most recent information about business service topologies but also provide support for change management, asset management and version control as information evolves. A “CMS” is a layer that federates and provides a single interface to multiple proprietary and heterogeneous 3rd party CMDBs. The terms “uCMDB” or “CMDB” are used herein to refer to what may be a federation of CMDBs accessed via the CMS.

The uCMDB 110 can include a dynamic discovery module (DDM). The DDM interacts with a variety of data collection agents 130 to continuously discover information about managed objects and their relationships and to reflect the information in CMDB. Automated discovery is useful in maintaining accurate and up-to-date information. Large systems can have millions of CI and updates to hundreds or more of CI per day. Additionally, IT services may update the CMDB when they make changes to the environment, and automated discovery can complement the tracking such changes.

Other data sources can provide measurements about the business service(s). The EUM 115, Events 120, and Third-Party Sources 125 shown in FIG. 1 are examples of these other data sources. Data sources can provide information such as workload information. The workload information can include data such as, demand traces for a service on computing components or devices within the system. The fact measurements 145 about a business service may define a service model, and the measurements may comprise information or relationships about or between workloads and demand traces. The service model can also include other information relevant to licensing or service level agreements. As shown in FIG. 1, the third-party sources may comprise an application 135 and/or data collection agents 130 which operate to collect measurements about the business service(s) or measurements relevant to the business service(s).

The topology 140, service level information, and business service measurements 145 (fact measures) can be stored in a performance management warehouse 150, or performance management database (PMDB), within the context of a business service's specific hierarchy. This enables the creation of business service optimization scenarios and reports on the results of analysis and/or on measurement data. The business service, or a business service model, may refer to system components such as hosts, virtual machines and so forth. The hosts and virtual machines can have unique identifiers. Monitoring systems produce demand traces for which can have the same unique identifiers as the hosts and virtual machines. When data is loaded into the PMDB via the ETL process a matching process can be performed to correlate the monitoring data from the monitoring system with particular hosts and/or virtual machines in the business service topology.

The PMDB 150 can automatically annotate each item of measurement data, or monitored data, with context information that is defined by each business service's own specific configuration items. For example, within the PMDB, a central processing unit (CPU) measurement can be associated with multiple tags that reflect a position of an application server associated with the CPU within the business service's topology. Categorizing data with multiple business service specific tags can provide a number of benefits. For example, all application components that are part of a business service can be selected for study in a planning scenario. Metrics such as CPU usage or power usage at several levels of abstraction (e.g., for a particular application server or for a business service as a whole) can be quickly summarized. Other information such as service level constraints on clusters of application servers can also be available for use in the planning scenarios.

Constraint information can specify a limit for resource utilization levels of each application server or provide that each application server reside on a separate physical server, for example. Other constraint examples include limits on how, when, and/or where a workload may be used with regards to available computing resources. Constraints can be automatically queried when creating planning scenarios from the PMDB and need not be discovered or added manually by a capacity planner. If a business service changes, a corresponding planning model can be updated automatically using the tag-based approach. In one configuration, constraints for workloads can be part of a workload model in the PMDB for managing and planning for the workloads in view of the constraints on workloads and/or computing devices.

In one example, some or all of the information for capacity planning stored in the PMDB 150 can be associated with tags or have tags assigned thereto. For example, tags can be assigned to computing resources within the topology model, to the workload model, to the facilities model, and to the service model. The tags can provide useful information, such as information about topology relationships, workload constraints, and service model services. The tags can provide specific information about particular system devices, such as a type of device, capabilities of the device, power consumption, compatibility, etc. The tags can also enable the system to easily account for constraints such as licensing or service level agreements. For example, a piece of software used in maintaining a business service may only be licensed for use on one or more specific machines. When creating a planning scenario, a machine(s) limitation for usage of that software can easily be identified and planned for by identifying a tag(s) associated with the software and/or machine(s).

Topology 140, measurement data 145, etc., can go through the Extract Transform Load (ETL) 155 and reconciliation 160 processes to conform to the information in the PMDB 150. In other words, data can be extracted from outside sources, transformed to fit operational standards in the PMDB and loaded into the PMDB. The information loaded into the PMDB can be reconciled with information already in the PMDB. The PMDB can include user-configurable ETL and reconciliation policies for handling of topology, measurement data etc. In one configuration, the policies for handling of topology information can vary from policies used in handling measurement information. After ETL and reconciliation, the data can be stored in a data mart 165 within the PMDB. The PMDB can include a single data mart for storing all of the capacity planning data or multiple data marts, such as a data mart for topology information, a data mart for measurement data, etc. The data mart can record information about data stored in the data mart. For example, the data mart may store information such as the time the data was received, the server from which the data was received, a fact (such as topology or measurement data), a service associated with the fact, etc. This information can be associated with the data in the form of tags, as described above. Because these tags can provide information on constraints, as well as topology relationships and so forth, the tags may also be generally referred to as “constraint tags” herein.

The PMDB 150 can be used to generate a capacity planning scenario for available computing resources based on the assigned constraint tags. For example, the topology model, the workload model, and the service model may be combined in the PMDB, and a capacity planning scenario can be generated based on the combined models in the PMDB. A system administrator may be apprised of the capacity planning scenario via generation of a report, using a reporting module 170. An analytics module 175 can also provide an analysis of system performance of the generated capacity planning scenario and may further provide a comparison with performance of the current system configuration.

A business service may have many component workloads. Each workload may have certain objectives (e.g., utilization of allocation desired to remain below a threshold). The business service may have additional objectives (e.g., total power usage desired to be less than some objective). Workloads can have joint constraints (e.g., certain workloads desired to or not desired to be on the same physical server, limit on min/max number of replicates of an application component, component desired to reside on a host with a particular license, etc.). Facilities may have constraints on peak power, time of day power, limits on space, etc. The uCMDB and/or the PMDB can capture constraint information in the context of business services and facilities. Some of the information in the PMDB may comprise information about mechanisms to get resource demand traces for constituent workloads, relationships between workloads, resource allocation policies for workloads, licensing constraints, business service objectives, etc. The facilities model can capture constraints on power, space, and other aspects of infrastructure to be reflected in a capacity planning scenario.

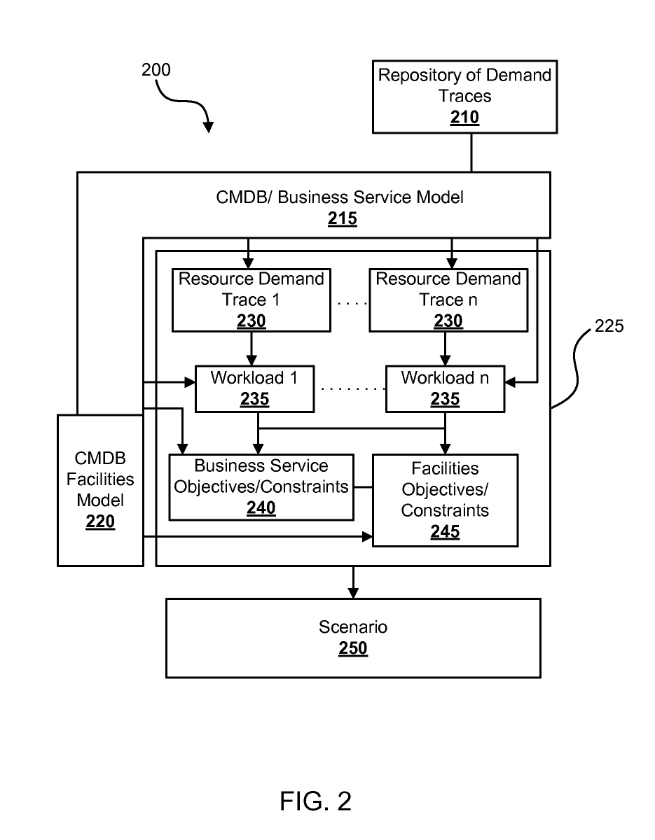

Referring to FIG. 2, a workflow 200 is shown for creating a capacity planning scenario using a computing system, in accordance with an example. A topology model of available computing resources is maintained in a configuration management database 215 or within a business services model. The topology model can include the computing devices within the system and can identify computing devices used by the business service. Facts related to the usage of available computing resources can be obtained using one or more data collection agents. The resource usage data can be directly related to a particular business service. In one example, the resource usage data may be obtained from a resource usage repository. In other words, the resource usage data may be historical resource usage. In another aspect, the resource usage data may be current or provided in real-time. As shown in FIG. 2, the resource usage may be in the form of demand traces obtained for the business service. The demand traces can be stored in a repository of demand traces 210 in communication with the CMDB.

Topology information can be projected from the CMDB to a data mart in the PMDB 225. Likewise, fact measures can be projected to the data mart. As shown in FIG. 2, the PMDB can store information about resource demand traces 1 through n 230, workloads 1 through n 235, etc. Constraint tags can be assigned to the projected topology model and facts. For example, the constraint tags may comprise information about topology relationships, computing resource capabilities, and services operated on the computing resources. Business service objectives 240, constraints on workloads and resources, etc. can be taken into consideration in creating a capacity planning scenario using the tags. Also, a CMDB facilities model 220 can provide facilities objectives or constraints 245 to the PMDB to be considered along with other objectives, constraints, etc. in creating the capacity planning scenario. A capacity planning scenario 250 can be created with constraints based on the topology model, facts, and constraint tags from the data mart.

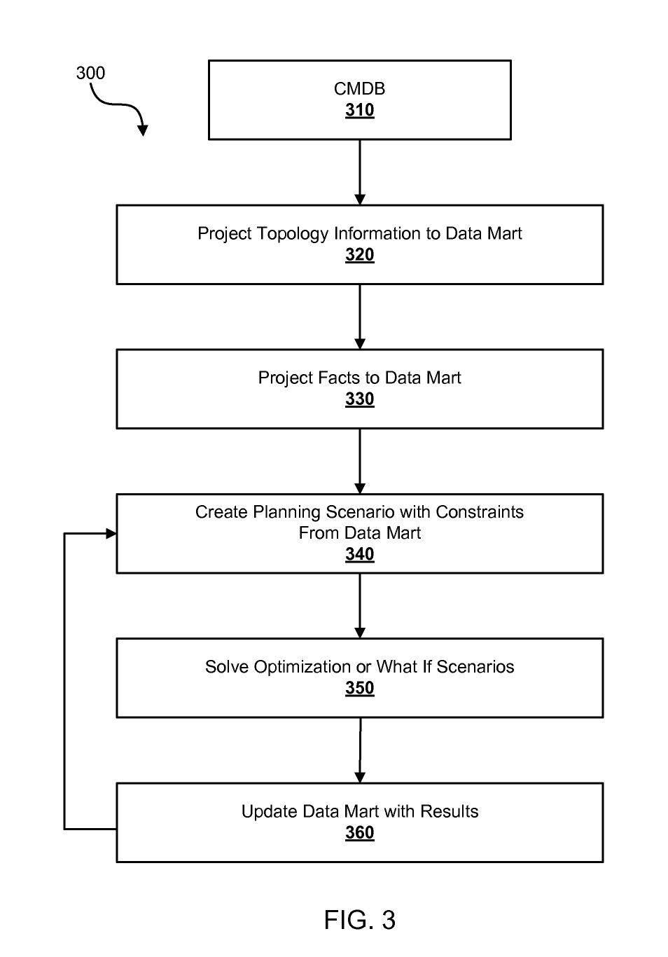

Referring to FIG. 3, a flow diagram 300 for creating a capacity planning scenario is shown, which is similar in many regards to the capacity planning scenario creation described above. A CMDB can maintain system topology information. The topology information can be projected 310 to a data mart. Facts can also be projected 320 to the data mart. A planning scenario with constraints can then be created 330 from the data mart. In addition, the capacity planning scenario can be optimized 340. For example, optimization may occur by altering a services and computing resource relationship. In other words, inclusion of new hardware, change in configuration of hardware or services, or rearrangement of which hardware is used for which service(s) or for a particular aspect of a service, etc., can improve service performance or decrease system resources used for the service. Therefore, the optimization may comprise testing various different configurations, arrangements, potential new hardware, etc. to determine an optimized configuration, or a configuration with a performance increase.

Also shown in FIG. 3 is the solving 340 of “what if” scenarios. Solving a what if scenario may comprise solving for potential changes in future usage of the available computing resources. Solving a what if scenario may comprise solving for potential changes in number of users of the available computing resources. Solving a what if scenario may also comprise solving for potential changes in future available computing resources. Other examples of potential what if scenarios and optimizations that may be apparent to one having skill in the art are also contemplated.

After a capacity planning scenario is created 330 and the capacity planning scenario has been optimized 340 or potential changes in the capacity planning scenario have been solved to obtain a result, the data mart can be updated 350 with the optimization or the result. In one aspect, updating the data mart with the optimization or the result may comprise updating the constraint tags in the data mart. Also, though not shown in FIG. 3, the CMDB can also be updated based on the updated constraint tags in the data mart.

The updated data mart can report an optimized planning scenario to an administrator. For example, specific computing resource usage metrics can be reported to the administrator, or user. In one aspect, the reported information can be defined by the user and based on the constraint tags.

In an example, the updated data mart information can be used to implement the planning scenario. In another example, a capacity planning scenario can be created based on the updated data mart. This capacity planning scenario can be a further improvement on a previous capacity planning scenario, or may be a different planning scenario simply created based off the updated information. Storing solutions to optimizations and what if scenarios can make further planning scenario creation faster and more efficient by eliminating the need to solve the optimizations or what if scenarios again in the future for similar situations. A report may report on the results of many scenarios.

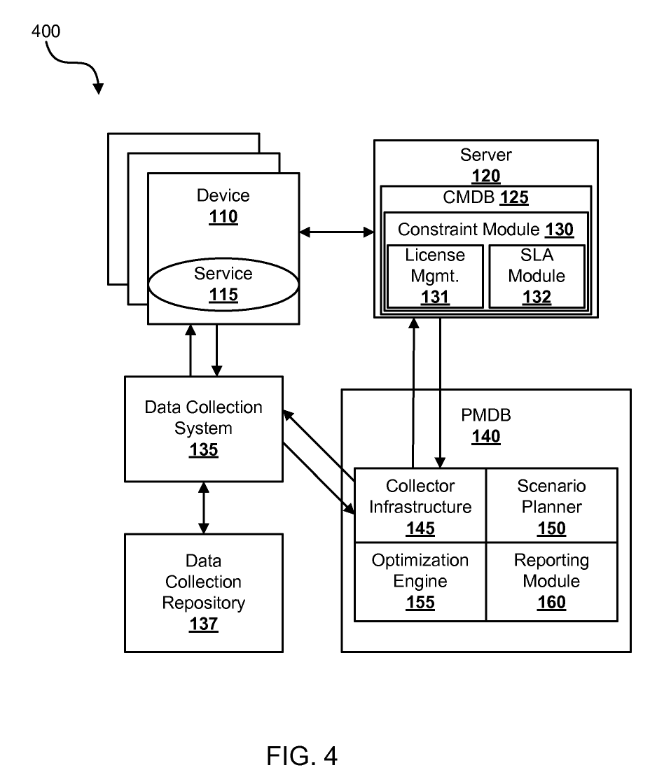

Topology, constraints, and operational usage information will now be described with reference to FIG. 4 and in terms of a system 400 for creating capacity planning scenarios in accordance with an example. As has been described above, the system can include or be in communication with a variety of computing devices 410, such as servers, processors, and so forth. One or more business services 415 can be operated on the computing devices. Each business service can have a topology that is a hierarchy of software and infrastructure managed objects. The managed objects can include, for example, web servers, application server pools, application servers, databases, virtual machines, and physical hardware such as servers, network and storage devices. The managed objects are described using CIs.

A CI can correspond to a managed object as simple as a CPU or as complex as a business service of an enterprise. For business service optimization, Infrastructure Service, Application, and Business Transaction CI can be used extensively. There are a large number of pre-existing data models with CI types that are defined to model information about complex business service topologies. Common application solution platforms such as SAP, .NET, MS Exchange and others have models of CIs with known hierarchies that are specific to such platforms. DDM modules can have special discovery capabilities to discover managed objects of these platforms and populate their corresponding model instances within the CMDB. Additionally, a user may create additional models, CI types, and CIs and store them in the CMDB 425.

The CMDB 425 may be hosted on a server 420 in communication with the computing devices and can be configured to maintain a topology of the computing devices. In addition to topology information, the CMDB can also maintain constraint information. The CMDB can include a constraint module 430 capable of maintaining the constraint information and also configured to assign constraint tags to the topology model and facts. Constraints can be limits on acceptable system configurations and behaviors. Constraints can also include acceptable outcomes for planning exercises. Some constraints can be inferred from existing CIs. For example, an inference may be made from an application server pool CI that multiple application servers should be associated with different physical servers to improve availability. Other constraints, such as constraints on costs, performance, and/or power usage, for example, can be modeled as CIs and explicitly added to the CMDB within the context of a service's topology.

Additional constraints may also be managed by the constraint module 430. For example, the constraint module may include a license management module 431. The license management module can be configured to upload licensing agreement information to the PMDB 440 for use in planning scenarios. The license management module can assign constraint tags to system resources based on the licensing agreement information as such information relates to the usage of the computing devices. The constraint module may further include a service level agreement management module 432. The service level agreement management module can be configured to project service level agreement information to the PMDB for use in scenario planning. The service level agreement management module can assign constraint tags to system resources based on the service level agreement information as such information relates to the usage of the computing devices.

Operational usage information such as end user response times, resource usage, resource availability, events, and service level measurements can also be used for planning scenarios. This information can be collected by probes, agent-less monitors and collection agents. The probes, monitors, agents, etc. may comprise a data collection system 435 configured to obtain facts related to the usage of the computing devices. The facts, or collected information, can be collected from infrastructure elements such as physical and virtual servers, applications, network devices, storage devices, etc. The information can include end user response times, transaction counts, availability information for applications, etc.

Usage information collected over time can be retained for some or all managed objects. For example, the usage information may include application transaction throughput, response time and server CPU usage. Typically there is a significant volume of such information for many CIs. As a result, this information may be stored in a collection of other repositories 437 rather than in the CMDB 425. These other repositories may be distributed across an enterprise.

The PMDB 440 can be a reconciliation of information from the CMDB 425 with operational usage information. A collector infrastructure 445 of the PMDB can gather information from operational usage repositories 435 or 437 and the CMDB. As described above, ETL content packs , which are software packages that facilitate the integration of data into data warehouses, read operational usage information, create measurement tables within a data mart that have device IDs, measurements, and the time dimension. Topology information from the CMDB can guide the content packs' definition of bridge tables, i.e., tables that maintain relationships, in the data mart that puts device measurements into context. In other words, the bridge tables can organize the measurements. Each CI in a topology can be inserted as a table row in the bridge tables and is a dimension for categorizing the measurement. Managed object identifier information that is common to both the operational data and the topology data can guide this reconciliation process so that each device is related to a relevant context. For example, within the PMDB, a CPU measurement table may be associated with multiple dimensions that reflect a relationship with a virtual machine (VM), an application server, an application server pool, a constraint, etc. In prior solutions, a CPU measurement may have only been associated with a virtual machine of a particular physical server. In the systems described herein, the multiple dimensions of the relationship can reflect the context of the CPU measurement within the whole business service topology. Categorizing data with multiple business service specific dimensions can provide a variety of benefits. For example, all application components that are part of a business service can be easily selected for study in a planning scenario. Metrics, such as CPU usage or power usage at several levels of abstraction (e.g., for a particular application server or for a business service) can be quickly summarized or aggregated. In a similar manner, topology facts can be associated with their constraints.

In one example, the PMDB 440 can support consolidation planning of scenarios that consolidates application servers to hosts. The scenario planning can use time varying historical resource usage information for the application servers and constraints on application server placements. A consolidation optimization engine can use this information to recommend application placements that minimize the number of hosts used to support the workloads. As described herein, the system may be configured to do more than simply consolidate resources. Therefore, the consolidation optimization engine may more generally be an optimization engine 455. As described above, such optimizations can include consolidation, optimization of capacity planning scenarios, or solving for potential changes in the capacity planning scenario.

Each application in a business service 415 can be associated with application servers. The application servers can each be associated with a virtual machine that is associated with a host. The application servers can have an inferred constraint that the associated virtual machines are to be assigned to different hosts for availability reasons. In a virtualized environment, the application servers may change association with hosts over time. By using the time varying resource usage information aggregated by application servers instead of by hosts the capacity planning system can tolerate the change in association of servers and hosts over time.

The PMDB 440 can enable development of scenario planning wizards to automate the creation of business service optimization and enterprise capacity planning scenarios. A scenario planning wizard, or simply a scenario planner 450, can help users engage in a capacity planning process. The wizard can interact with the PMDB to report on inventories of managed objects and resource usage. A wizard can identify opportunities for optimization, such as low resource utilization or high power usage. Once a user decides on an opportunity to evaluate, the wizard supports the analysis process by automating the creation of the scenario as a planning model by obtaining information organized within the PMDB and preparing a model(s)s, solving the model(s) using an optimization engine, storing the results in the PMDB, and then reporting the results. The user may wish to view various alternative scenarios and compare the alternatives with respect to metrics, including cost, power, and resource access quality of service as summarized across the dimensions of the service topology. Reporting the scenarios, the comparisons, the metrics, and so forth via a reporting module 460 can help a user make a final recommendation.

Scenarios can be aware of constraints. A virtual machine may have placement constrained to a specific list of hosts. Application server virtual machines may be constrained to be assigned to a same physical host, or to different physical hosts. A user is able to modify constraints or add new constraints in scenarios and these constraints may be taken into account by optimization engines. A quality of service constraint can specify what portion of each unit of demand is to be satisfied when consolidating workloads. A quality of service constraint value of 100%, for example, can specify that all demands are to be satisfied all the time in the consolidation exercise. Peaks are often short term, intermittent spikes in demand. A quality of service constraint value of 99%, for example, may specify that resources can be consolidated so long as a unit of demand is satisfied with a probability of 0.99 or more. Smaller quality of service constraint values can indicate more aggressive consolidation. Headroom constraints can scale demands for analysis purposes to ensure that each workload has sufficient idle time on resources to provide adequate response times or to plan for future growth in workload intensity.

The consolidation optimization engine 455 can provide information regarding resource access quality of service constraints, placement constraints, and headroom constraints. The consolidation optimization engine can also recommend workload placements that minimize the number of hosts needed to support a business service while satisfying constraints or while addressing various objectives such as power usage and cost.

The system can consider business service topology information, top-down application monitoring information, e.g., transaction counts and response times, and bottom up operational resource usage information, e.g., CPU and memory usage, in planning scenarios. The system can also quickly report and summarize usage data based upon topology; quickly prepare portal screens and custom logic that implements additional kinds of analysis wizards; export summarized information in formats for optimization solvers; and import and compare results. As a result, the system can be used not only for tasks such as virtual machine consolidation and load balancing exercises for shared server pools, but also for assessment, planning, and predictive modeling studies.

Some of the functional units described in this specification have been labeled as modules or engines, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Also within the scope of an example of the systems and methods herein is the implementation of a program or code that can be stored in a machine-readable medium to permit a computer to perform any of the methods described above.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

While the forgoing examples are illustrative of the principles of capacity planning scenario creation in one or more particular applications, it will be apparent to those of ordinary skill in the art that numerous modifications in form, usage and details of implementation can be made without the exercise of inventive faculty, and without departing from the principles and concepts described herein. Accordingly, no limitation is intended, except as by the claims set forth below.

1. A computer-implemented method for creating a capacity planning scenario using a computing system, comprising:
maintaining a topology model of information technology components as relating to computing resources in a configuration management database, wherein the topology model includes at least one computing device and at least one facility in which the computing device is used;
maintaining a workload model of workload constraints for workloads on the computing resources, wherein the constraints comprise limits on at least one of how, when, and where the workload may be used with regards to the computing resources;
maintaining a service model of business services for workloads on the computing resources, wherein the service model comprises relationships between workloads and demand traces;
assigning constraint tags to the computing resources within the topology model, workload model, and service model, wherein the constraint tags comprise information about topology relationships, workload constraints, and service model services; and
generating a capacity planning scenario for the business services, workloads, and computing resources based on the assigned constraint tags.

2. A method in accordance with claim 1, further comprising maintaining a facilities model and assigning constraint tags to computing resources within the facilities model.

3. A method in accordance with claim 1, wherein the service model further comprises licensing constraints.

4. A method in accordance with claim 1, further comprising combining the topology model, the workload model, and the service model in a performance management warehouse within the context of a business hierarchy, and wherein generating a capacity planning scenario comprises generating a capacity planning scenario based on the combined models in the performance management warehouse.

5. A computer-implemented method for creating a capacity planning scenario using a computing system, comprising:
maintaining a topology model of computing resources in a configuration management database, wherein the topology model includes a plurality of computing devices;
obtaining facts related to the usage of the computing resources using a data collection agent;
projecting the topology model to a data mart;
projecting the facts to the data mart;
assigning constraint tags to the projected topology model and facts, wherein the constraint tags comprise information about topology relationships, computing resource capabilities, and services operated on the computing resources; and
creating a capacity planning scenario with constraints based on the topology model, facts, and constraint tags from the data mart.

6. A method in accordance with claim 5, further comprising optimizing the capacity planning scenario by altering a services and computing resource relationship.

7. A method in accordance with claim 5, wherein creating a capacity planning scenario further comprises solving for potential changes in future usage of the computing resources.

8. A method in accordance with claim 5, wherein creating a capacity planning scenario further comprises solving for potential changes in future computing resources.

9. A method in accordance with claim 5, wherein creating a capacity planning scenario further comprises optimizing the capacity planning scenario or solving for potential changes in the capacity planning scenario to obtain a result, and the method further comprises updating the data mart with the optimization or the result.

10. A method in accordance with claim 9, further comprising creating a capacity planning scenario based on the updated data mart.

11. A method in accordance with claim 9, wherein updating the data mart with the optimization or the result further comprises updating the constraint tags in the data mart, the method further comprising updating the configuration management database based on the updated constraint tags in the data mart.

12. A method in accordance with claim 5, further comprising reporting the capacity planning scenario to a user.

13. A method in accordance with claim 12, wherein reporting the capacity planning scenario further comprises reporting specific computing resource usage metrics defined by the user and based on the constraint tags.

14. A method in accordance with claim 5, wherein assigning constraint tags to the projected topology model and facts further comprises assigning constraint tags based on licensing agreements.

15. A method in accordance with claim 5, wherein assigning constraint tags to the projected topology model and facts further comprises assigning constraint tags based on service level agreements.

16. A system for creating a capacity planning scenario, comprising:
a plurality of computing devices;
a configuration management database hosted on a server in communication with the plurality of computing devices and configured to maintain a topology of the plurality of computing devices;
a data collection system configured to obtain facts related to the usage of the plurality of computing devices;
a performance management database configured to receive and store the topology and the facts;
a constraint tag assignment module configured to assign constraint tags to the projected topology model and facts, wherein the constraint tags comprise information about topology relationships, computing device capabilities, and services operated on the plurality of computing devices; and
a scenario planner configured to create a capacity planning scenario with constraints based on the topology model, facts, and constraint tags from the performance management database.

17. A system in accordance with claim 16, further comprising a reporting module configured to report the capacity planning scenario to a user.

18. A system in accordance with claim 16, further comprising a license management module configured to project licensing agreement information to the performance management database to be assigned constraint tags by the constraint tag assignment module based on the licensing agreement information, wherein the licensing agreement information is related to the usage of the plurality of computing devices.

19. A system in accordance with claim 16, further comprising a service level agreement management module configured to service level agreement information to the performance management database to be assigned constraint tags by the constraint tag assignment module based on the service level agreement information, wherein the service level agreement information is related to the usage of the plurality of computing devices.

20. A system in accordance with claim 16, further comprising an optimization engine configured to optimize the capacity planning scenario or solve for potential changes in the capacity planning scenario to obtain a result, and further configured to update the performance management database with the optimization or the result.
